(19) United States
(12) Patent Application Publication
(10) Pub. No.: US 2022/0238999 A1
(43) Pub. Date: Jul. 28, 2022

(54) CLOSE-RANGE COMMUNICATION SYSTEMS FOR HIGH-DENSITY WIRELESS NETWORKS

(71) Applicant: Cypress Semiconductor Corporation, San Jose, CA (US)

(72) Inventors: Zhuohui Zhang, Tustin, CA (US); Daniel Oloumi, Villach (AT); Matteo Bassi, Padova (IT); Kiran Uln, Pleasanton, CA (US)

(73) Assignee: Cypress Semiconductor Corporation, San Jose, CA (US)

(21) Appl. No.: 17/348,144

(22) Filed: Jun. 15, 2021

Related U.S. Application Data
(60) Provisional application No. 63/141,812, filed on Jan. 26, 2021.

(51) Int. Cl. H01Q 7/00; H01Q 21/00; H01Q 1/24; H04W 52/36; H01Q 5/30

(52) U.S. Cl. CPC H01Q 7/00; H01Q 21/0025; H01Q 5/30; H04W 52/367; H01Q 1/242

(57) ABSTRACT

Implementations disclosed describe devices and systems for close-range communications in high-density wireless network environments. A close-range antenna configured according to disclosed implementations generates a sufficiently strong near-field signal to ensure a reliable close-range communication. Additionally, the signal decreases significantly with the distance from the antenna and, therefore, contributes little in the way of interference and noise for other devices of the wireless environment. Various antenna systems that achieve this objective are disclosed.

### RELATED APPLICATIONS

This application claims the benefit of U.S. Provisional Application No. 63/141,812, filed Jan. 26, 2021, the entire contents of which is being incorporated herein by reference.

### TECHNICAL FIELD

The disclosure pertains to wireless networks; more specifically, to improving quality of wireless communication links between network devices while reducing interference and noise from other network devices present in high-density wireless networks.

### BACKGROUND

Modern wireless networks often support connections of multiple devices that transmit wireless signals concurrently with other devices. Simultaneous wireless transmission increases the likelihood of interference that can be detrimental to reliability and throughputs of various individual communication links. Furthermore, simultaneous transmission produces electromagnetic noise that can further degrade quality of wireless communications. As the size of modern transmitting and receiving devices tends to decrease while spatial density of such devices often increases significantly (together with the demands to the throughput of communication links), ensuring adequate quality of network connections is important for continuing progress of the wireless technology.

### BRIEF DESCRIPTION OF THE DRAWINGS

FIG. 1 depicts schematically a high-density wireless environment, in accordance with some implementations of this disclosure.

FIG. 2A is a schematic depiction of an example wireless network device capable of supporting close-range communications without significantly contributing to the noise and interference at far field, in accordance with some implementations.

FIG. 2B is a schematic illustration of bandwidth control and channel selection during close-range transmission and/or receptions by a wireless networking device operating in accordance with some implementations of the present disclosure.

FIG. 3A is a schematic depiction of an example antenna assembly that enables efficient close-range communication while preventing far-field noise and interference, in accordance with some implementations of the present disclosure.

FIG. 3B depicts a rectangular close-range loop antenna.

FIG. 3C depicts a circular close-range loop antenna.

FIG. 4A is a schematic spatial characterization of the efficiency of a close-range communication that involves an antenna constructed in accordance with some implementations of the present disclosure.

FIG. 4B depicts schematically an angular misalignment between transmitting and receiving antennas that still allows for an efficient close-range wireless communication.

FIG. 4C depicts schematically a lateral misalignment between transmitting and receiving antennas that still allows for an efficient close-range wireless communication.

FIG. 4D is a schematic illustration of a wireless communication device capable of supporting wireless communication links to multiple end devices, in accordance with some implementations of the present disclosure.

FIG. 5A depicts an example side-by-side placement of a close-range antenna and a wireless network processor.

FIG. 5B depicts an example placement of a close-range antenna and a wireless network processor on opposite surfaces of a laminate.

FIG. 5C depicts an example placement in which a close-range antenna is integrated with wireless network processor into a single bundle device.

FIG. 5D depicts an example cross section of the combined bundle device of FIG. 5C.

### DETAILED DESCRIPTION

High-density networks include devices, e.g., sensor arrays, whose circuit boards support multiple transmitters. High-density networks may also include charging pads (charging mats) that support wireless simultaneous charging connections of multiple devices, testing benches used in device manufacturing, wireless access points in public spaces, printed circuit boards with multiple transmitters, and the like. In some instances, tens of devices may be located within a distance of several centimeters (e.g., on printed circuit boards), or hundreds of devices may be located within a distance of one meter (e.g., on testing benches). Conventional solutions to simultaneous wireless communications of multiple devices include targeted placement of antennas, formation of complex interference patterns of transmitted radiation (beamforming) using multiple-input multiple-output (MIMO) antennas with maxima in the directions of targeted devices (and minima in the direction of other, unintended, devices), using carrier-sense multiple access with collision avoidance (CSMA/CA), code-division multiple access (CDMA) or time-division multiple access (TDMA), in which the same channels are shared among multiple communication links in the time or spectral domains. Such solutions have a number of shortcomings, including expensive MIMO antenna designs, reduced data transmission rates, lost air time, complex protocols and software for time/spectral multiplexing, poor robustness against adjacent channel interference, large-size hardware required for implementation of such solutions, and so on.

Aspects and implementations of the present disclosure address these and other limitations of the existing technology by enabling systems and methods of close-range communications that provide good signal strength in the near field communications but have reduced signal strength in the far field domain. This, on one hand, ensures that nearby devices A and B have a robust and reliable network communication capable of transmitting and receiving large amounts of data quickly and efficiently. On the other hand, because of a sufficiently fast decay of the radiated field with distance, the A-B communication link adds little in the way of interference and noise that might affect communications of other, e.g., C, D, etc., devices. In turn, if other devices deploy the same or a similar technology, the A-B communication link remains largely free from adverse interference and noise that may be caused by other wireless communications occurring nearby. Such a close-range communication ability is enabled by systems and components that include one or more close-range antennas, as described herein.

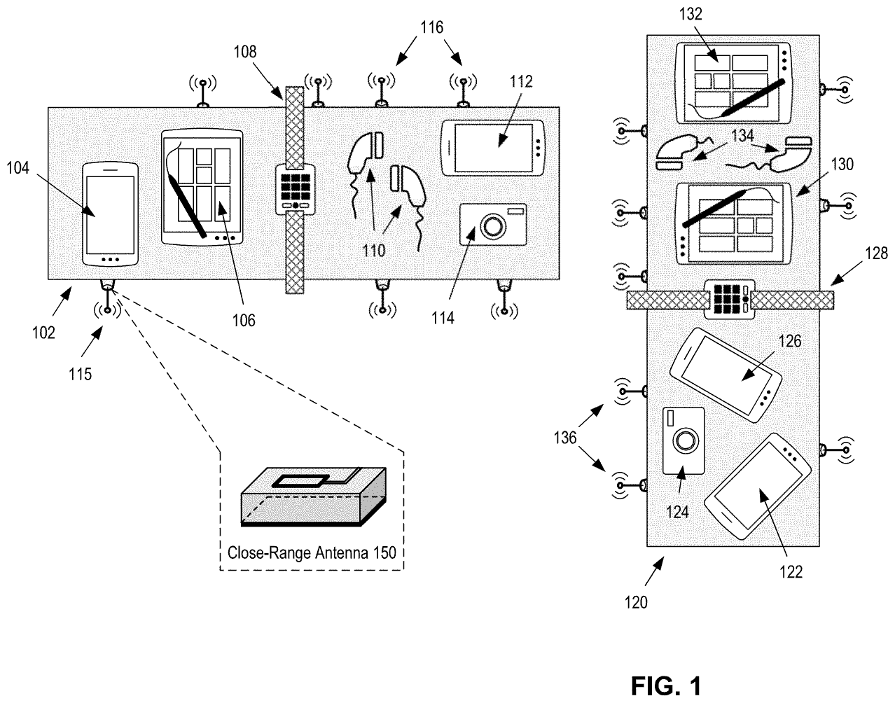

FIG. 1 depicts schematically a high-density wireless environment, in accordance with some implementations of this disclosure. Depicted are charging pads 102 and 120 that support wireless charging of multiple devices, e.g., smart phones 104, 112, 122, and 126, tablet computers 106, 130, and 132, smart watches 108 and 128, earbuds 110 and 134, camera 124, etc. Connectivity of different devices to charging pads 102 and 120 may be supported by various antennas 116 and 136 operating in accordance with various systems and techniques described herein. Even though illustrated in FIG. 1 are charging pads, implementations described herein may equally apply to any other networks with high densities of communicating devices.

In some implementations, close-range communication may be mediated by relatively high-frequency radio carriers, e.g., 60 GHz radio waves having a wavelength of about 5 mm in vacuum (or air). In other implementations, however, communications that use radio waves with lower frequencies, e.g., 30 GHz or lower, may similarly benefit from systems described in this disclosure. Higher frequency waves have a tendency to scatter and attenuate faster than lower frequency waves, e.g., communications that utilize 60 GHz waves generally do not have a range of 5 GHz or 2.4 GHz wireless networks. Higher frequency radio waves, however, enable higher bandwidths and, correspondingly, faster data exchanges. Even though multiple references to the 60 GHz band are made throughout this disclosure, it should be understood that the 60 GHz band may have a significant bandwidth, e.g., 8 GHz, so that the actual transmission of radio waves may take place within a broad range of frequencies, e.g., 57-64 GHz band (or 57-71 GHz, in some countries). The 60 GHz communications may use Wireless Gigabit (WiGig) IEEE 802.11ad standard with data throughput up to 4,600 Mps (or even higher, under favorable conditions), namely four times faster than the IEEE 802.11ac standard (which uses 5 GHz band) allows.

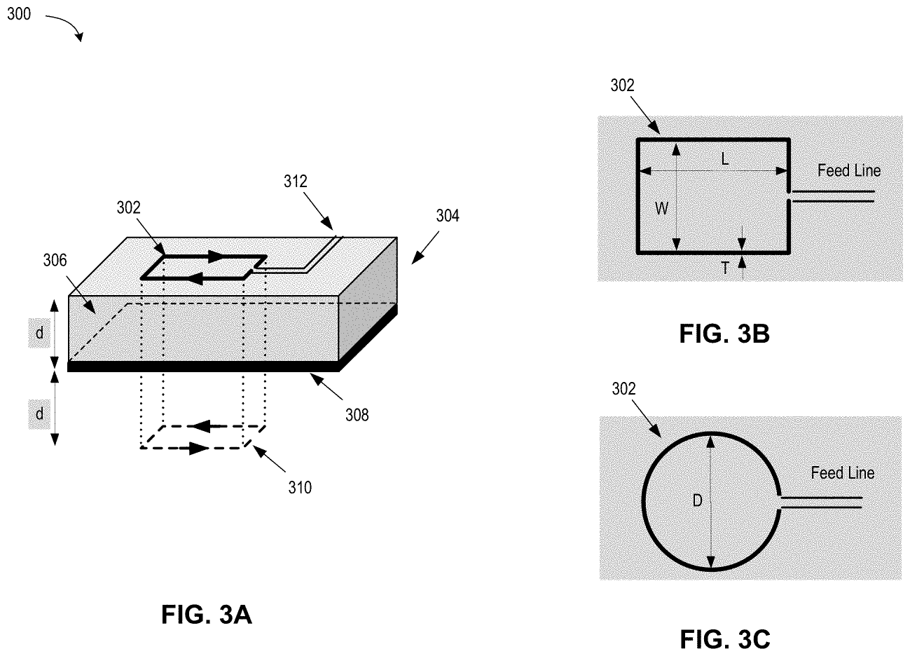

As depicted by the blowout section of FIG. 1, a wireless communication between any devices (e.g., charging pad 102 and smart phone 104) may be facilitated by a close-range antenna assembly (e.g., antenna assembly 115), which may include a close-range antenna 150. As described in more detail in connection with FIG. 3, close-range antenna 150 may include, in one or more implementations, a loop antenna operating in conjunction with a specially engineered substrate. The loop antenna may be of a small size in order to reduce far-field radiation. The loop antenna may be in proximity to a substrate (e.g., dielectric substrate) that separates the loop antenna from a conducting layer. The conducting layer enhances the electromagnetic field in the near-field region by redirecting (reflecting) upwards the field emitted in the downward direction.

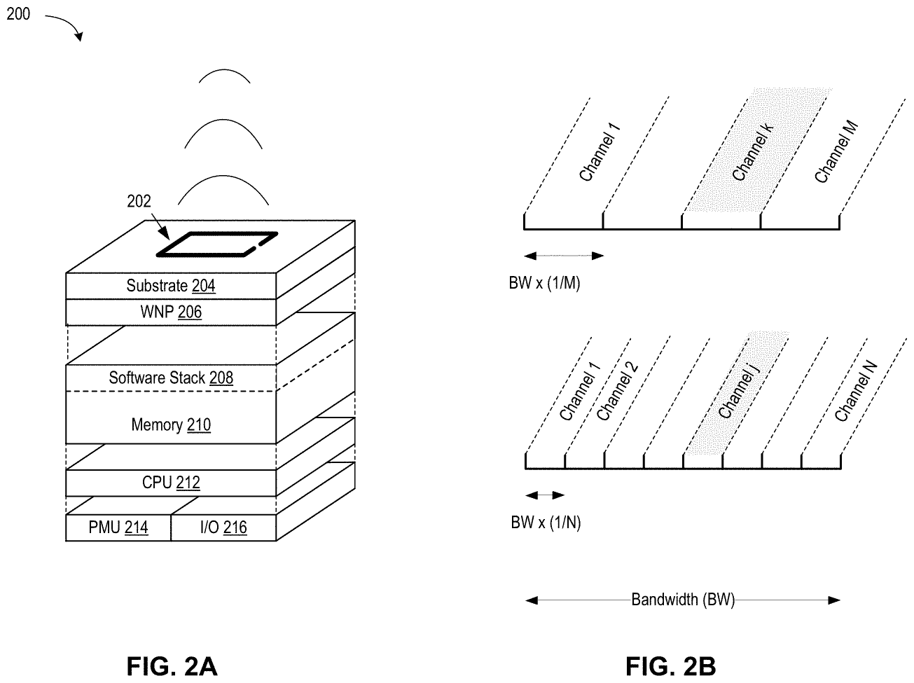

FIG. 2A is a schematic depiction of an example wireless network device 200 capable of supporting close-range communications without significantly contributing to the noise and interference at far field, in accordance with some implementations. Wireless network device 200 may be a station device e.g., a charging pad 102 or charging pad 120, a testing bench, a sensor array, an access point of a public service network, and so on. Wireless network device 200 may be capable of obtaining or generating digital data, forming data frames that include generated data, transforming the data frames into data packets, and transmitting the data packets over a wireless connection, among other operations. Wireless network device 200 may also be capable of performing these operations in a reverse order, when data packets are being received from another device. Modules and components of wireless network device 200 may be operating in accordance with any suitable wireless protocol, e.g., IEEE 802.11ad protocol.

Wireless network device 200 may include close-range antenna 202 capable of transmitting electromagnetic waves, receiving electromagnetic waves, or both. Close-range antenna 202 may be communicatively coupled to a suitable feed line (not shown) that delivers a transmission (TX) radio signal to close-range antenna 202 or obtains a reception (RX) radio signal received by antenna 202. The feed line may be any suitable transmission line, waveguide, and the like. The feed line may be coupled to close-range antenna 202 via any suitable coupling mechanism, e.g., capacitive coupling, inductive coupling, combined capacitive-inductive coupling, direct contact coupling, and the like. Close-range antenna 202 may be supported by substrate 204. Substrate 204 may be or include any printed circuit board. As described in more detail below in conjunction with FIG. 3, substrate 204 may include any number of conducting and/or non-conducting (insulating or dielectric) layers deposited on a printed circuit board or any other type of support.

In some implementations, substrate 204 may be deposited directly over a wireless network processor (WNP) 206. In some implementations, WNP 206 may be located differently, e.g., side-to-side with close-range antenna 202. WNP 206 may perform a number of functions, including but not limited to authenticating wireless connections, forming, processing, routing, and scheduling for transmission data packets, performing cryptographic encoding and decoding of the data packets, coordinating data packet transmission. WNP 206 may perform operations for both TX and RX data exchanges. WNP 206 may have a radio component which includes filters (e.g., band-pass filters), low-noise radio-frequency amplifiers, down-conversion mixer(s), intermediate-frequency amplifiers, analog-to-digital converters, inverse Fourier transform modules, deparsing modules, interleavers, error correction modules, scramblers, and other (analog and/or digital) circuitry that may be used to process modulated signals received by close-range antenna 202. The radio component may provide the received (and digitized) signals to a physical layer (PHY) component of WNP 206. During reception, the PHY component may convert the digitized signals into frames that may be fed into a media access control (MAC) component of WNP 206. The MAC component may transform frames into data packets. During transmission, data processing may occur in the opposite direction, with the MAC component transforming data packets into frames that are then transformed by PHY component into digital signals provided to the radio component. The radio component may convert digital signals into radio signals and transmit the radio signals using close-range antenna 202. In some implementations, the radio component, the PHY component, and the MAC component of WNP 206 may be implemented on a single integrated circuit.

Wireless network device 200 may include a software stack 208 that includes one or more applications that use wireless communications to transmit and/or receive data packets or other types of wireless signals. For example, software stack 208 may include a smart sensor array application, a data download/upload application, a video/audio application, a computational application, a testing application, or any other type of application that may be instantiated on example wireless network device 200. In some implementations, an application that is making use of WNP 206 may be a charging application that utilizes a power of RX radio waves to charge one or more batteries of wireless network device 200. Similarly, an application that is making use of WNP 206 may utilize TX waves to provide charging power to one or more end devices that are in a wireless communication with wireless network device 200. Software stack 208 may be loaded in memory 210, which may be (or include) any non-volatile, e.g., read-only (ROM) memory, and volatile, e.g., random-access (RAM), memory.

Wireless network device 200 may include one or more central processing units (CPUs) 212. In some implementations, CPU 212 may include one or more finite state machines (FSMs), field-programmable gate arrays (FPGAs), application-specific integrated circuits (ASIC), or the like. Wireless network device 200 may have a single CPU 212 that executes various operations of close-range communications in cooperation with WNP 206. In some implementations, CPU 212 may perform operations of software stack 208 whereas all (or most) wireless communication operations are performed by WNP 206.

Wireless network device 200 may also include a power management unit (PMU) 214 to manage clock/reset and power resources. Wireless network device 200 may further include an input/output (I/O) controller 216 to enable communications with other external devices (including non-network devices) and structures. In some implementations, I/O controller 216 may enable a general purpose I/O (GPIO) interface, a USB interface, a PCM digital audio module, and other I/O components.

Wireless network device 200 may be capable of a wireless connectivity (including simultaneous and concurrent connectivity) with more than one network. Wireless network device 200 may be capable of connectivity to various types of networks, including wireless local area networks (WLAN), wide area networks (WAN), personal area networks (PAN), mesh networks, internet-of-things networks, and the like, or any combination thereof. Wireless network device 200 may be capable of connectivity at 60 GHz as well as at 30 GHz, 5 GHz, 2.4 GHz, or at any other suitable band. Wireless network device 200 may, therefore, have multiple antennas configured to enable connectivity at different bands. In some implementations, wireless network device 200 may be capable of connectivity with multiple networks using the same band. For example, wireless network device 200 may be capable of close-range connectivity (e.g., up to several centimeters) at 60 GHz and a longer-range (e.g., several meters or longer) WiGig connectivity at the same 60 GHz band. This dual capability may be facilitated by wireless network device 200 having multiple 60 GHz antennas, e.g., close-range antenna 202 and a longer-range antenna (not depicted in FIG. 2A for conciseness). In some implementations, the two antennas may be separated from each other by a distance of several centimeters, to reduce interference. Some of the additional antennas of wireless network device 200 may be MIMO antennas deployed in the context of other techniques referenced above. For example, WiGig antenna(s) may be MIMO antenna(s) to be used with beamforming techniques, which may be utilized to direct maxima of beamformed signals away from close-range antenna 202. In some implementations, close-range antenna 202 may be a loop antenna whereas a WiGig antenna may be a dipole (or patch) antenna.

Various components of wireless network device 200 may be implemented as parts of a single integrated circuit (IC) (e.g., disposed on a single semiconductor die). For example, WNP 206 and CPU 212 may so be implemented. Close-range antenna 202 may also be disposed on the same die, although in some implementations, close-range antenna 202 and/or other parts of wireless network device 200 may be implemented on different dies. For example, close-range antenna 202 may be implemented on a die that is separate from a die on which WNP 206 (or CPU 212) is implemented. One or more dies that implement various components of wireless network device 200 may also host multiple other components. For example, a die that supports close-range antenna 202 may further host multiple other antennas.

In some implementations, wireless network device 200 may have a tunable matching network (e.g., as part of WNP 206) configured to control channel selection and channel bandwidth used by close-range antenna 202. FIG. 2B is a schematic illustration of bandwidth control and channel selection during close-range transmission and/or receptions by a wireless networking device operating in accordance with some implementations of the present disclosure. The top panel of FIG. 2B depicts a total available frequency bandwidth (e.g., 8 GB interval of 57-65 GHz frequencies, or any other suitable interval) split into four channels (or any other number M of channels), e.g. four 2 GB channels, as may be set up by the tunable matching network. The tunable matching network may further select (indicated by shadowing) channel k for transmission (and/or reception) by close-range antenna 202. (In some implementations, separate channels for transmission and reception may be selected.) At a later time, WNP 206 (or CPU 212) may determine that multiple other devices have joined the network at nearby locations. To decrease interference, the tunable matching network may reconfigure (e.g., upon instructions from a lead/router device of the network) transmission (and/or reception) by close-range antenna 202 to one of channels of a smaller (or larger) bandwidth. For example, as depicted by the bottom panel of FIG. 2B, the total available frequency bandwidth may be split into a different number of channels N, e.g., eight 1 GHz channels. The tunable matching network may further select (as indicated by shadowing) a narrower channel j for transmission (and/or reception) by close-range antenna 202. A similar channel reconfiguration (e.g., back to a smaller number of broader channels) may be performed at any moment, as dictated by the current conditions of the environment and/or the amount of data that needs to be communicated. Generally, a larger number of narrower channels may be favored when reducing interference/noise is important, whereas a smaller number of broader channels may be used when a greater throughput is desired.

Additional channel selection control provided by the tunable matching network may include polarization control. Specifically, each channel may support two sub-channels having different polarizations, e.g., perpendicular linear polarization, circular (or elliptical) polarizations rotating in opposite directions, and the like. Two communication links deploying different polarizations may be robust against mutual interference even when using the same frequency. In some implementations, two different polarizations may be generated by controlling the current in the antenna provided by WNP 206.

FIG. 3A is a schematic depiction of an example antenna assembly 300 that enables efficient close-range communication while preventing far-field interference and noise, in accordance with some implementations of the present disclosure. Depicted is a loop antenna 302 supported by a substrate 304. Shown is one possible substrate 304 that includes a conducting layer 308 and an insulating (non-conducting) layer 306 that separates loop antenna 302 from the conducting layer 308. In some implementations, both the conducting layer 308 and the insulating layer 306 may be manufactured during the same deposition process on top of a wafer (not depicted for simplicity of viewing). Loop antenna 302 may be coupled to a feed line 312, which may be a waveguide, a coaxial cable, a transmission line (e.g., a line that includes two or more wires), and the like. The feed line 312 may lead to an antenna matching network (not shown), which may include impedance transformer to interface loop antenna 302 with a radio frequency amplifier (e.g., of WNP 206 in FIG. 2A) in a way that minimizes undesirable power losses during signal transmission/reflection.

In some implementations, an example antenna assembly 300 enables efficient close-range communication but produces a reduced far field. The shape of the loop antenna 302 ensures that, unlike dipole antennas, emission by the antenna is of a magnetic dipole type, which has a reduced strength (compared with dipole or patch antennas) in the far field domain (e.g., at distances from the loop antenna 302 that are at least several times the wavelength of the emitted waves). Dimensions of close-range antenna 302 may be comparable to or smaller than the wavelength of the waves in vacuum, e.g., λ₀=c/f≈5 mm at operational frequency f=60 GHz. In some implementations, a circumference of the antenna may be in the millimeter range, e.g., 1-2 mm. FIG. 3B and FIG. 3C are depictions of various possible designs of the loop antenna 302, with FIG. 3B depicting a rectangular close-range loop antenna and FIG. 3C depicting a circular close-range loop antenna.

In some implementations, the loop antenna 302 may have a square shape with length L and width W being approximately equal, L≈W. In some implementations, the size of the antenna (e.g., its length L, width W, or diameter D) may be less than a quarter wavelength of the transmitted/received waves: L,W<λ₀/4 (or D<λ₀/4). In some implementations, the size of the antenna may be less than one eighths of the wavelength of the transmitted/received waves: L, W<λ₀/8 (or D<λ₀/8). For example, in some implementation, L≈W≈0.3−0.5 mm. In some implementations, the shape of the loop antenna 302 may be rectangular, but not square. In some implementations, the shape of the loop antenna 302 may be non-rectangular, e.g., being of a triangular, hexagonal, or some other polygonal form. The thickness of the wire of which the loop antenna 302 is made may be different in different implementations, e.g., T≈0.05 mm in one non-limiting example.

Conducting layer 308 (herein also referred to as a conducting screen) may be made of a good conductor, such as copper, silver, gold, or some other conductor with the conductivity at least 10⁶ Siemens/m. In contrast, insulating layer 306 may be made of a dialectic or a poor conductor, such as an undoped silicon, silicon dioxide, or some other insulating material with the conductivity at most 10² Siemens/m. Conducting layer 308 may serve multiple purposes. Firstly, it prevents emission of waves into the lower hemisphere (referring to geometry of FIG. 3A) and thus maintains electromagnetic energy above the conducting layer 308. This reduces losses and decreases interference with devices that may be located on the other side of conducting layer 308. Secondly, electric currents and charges generated in the conducting layer 308 amount to an appearance of an image loop 310, in which (as depicted in FIG. 3A) electric current circulates in a direction opposite to the direction of electric current in the loop antenna 302. If d is the thickness of the insulating layer 306, the image loop 310 is located at distance 2d under the loop antenna 302.

The existence of the image loop 310 negates significantly the electromagnetic field in the far field domain (which may be viewed as a quadrupole magnetic radiation from two oppositely circulating loop currents). In the near field, however, the negating effect of the image loop 310 is less significant. In some implementations, additional increase in the near filed may be achieved by constructive interference of the field emitted by the loop antenna 302 and the image loop 310. More specifically, if the square root of the dielectric constant of the insulating layer 306 is n, the wavelength of electromagnetic waves in the insulating layer 306 is λ=λ₀/n. For example, for silicon the square root of the dielectric constant is n≈3.45, and for silicon dioxide n≈1.95. For the waves propagating in the vertical direction, the additional phase acquired by the field emitted by the image loop 310 is ϕ2π×2d/λ, which for d≈λ/4 amounts to the π phase shift. This phase shift compensates for the opposite direction (relative to the loop antenna 302) of the electric current in the image loop 310, so that the electromagnetic fields produced by the two loops interfere constructively. In some implementations, the exact condition of constructive interference need not be satisfied, as an enhancement (albeit less than the maximum possible) may be achieved for phase shifts that are within ϕ∈(3π/4, 5π/4), which amounts to thickness of the insulating layer 306 being within the range d∈(3λ/16, 5λ/16).

In one example implementation, the conducting layer is at a distance d=0.306 mm of a silicon layer, for which λ≈1.45 mm. Accordingly, the maximum of the sum of the two waves is achieved for d=λ/4≈0.36 mm whereas at least some enhancement is present as long as d∈(0.27 mm, 0.45 mm).

In another example implementation, the conducting layer is at a distance d=0.69 mm of the glass-reinforced epoxy laminate material FR4, for which n=2.14 and λ≈2.336 mm. Accordingly, the maximum of the sum of the two waves is achieved for d=λ/4≈0.6 mm whereas at least some enhancement is present as long as d ∈(0.44 mm, 0.74 mm).

In some implementations, an efficient antenna may be constructed outside the range of optimal enhancement. For example, in yet another implementation, the conducting layer is at a distance d=0.4 mm of the multi-layered material MCL-E-770G for which n=2.14 and λ≈2.336 mm. Accordingly, the maximum of the sum of the two waves is achieved for d=λ/4≈0.59 mm whereas at least some enhancement is present as long as d ∈(0.44 mm, 0.74 mm), so that the distance d is outside the range of enhancement.

In some implementations, the thickness of the insulating layer 306 may be kept under half the wavelength in the respective material, d<<λ/2. In some implementations, as highlighted by the above-referenced examples of the FR4 and MCL-E-770G materials, the insulating layer 306 may be a composite material made of multiple layers having somewhat different dielectric constants. For example, insulating layer 306 made mostly of silicon may also include a layer of silicon dioxide (which may be a layer that is directly in contact with the loop antenna 302).

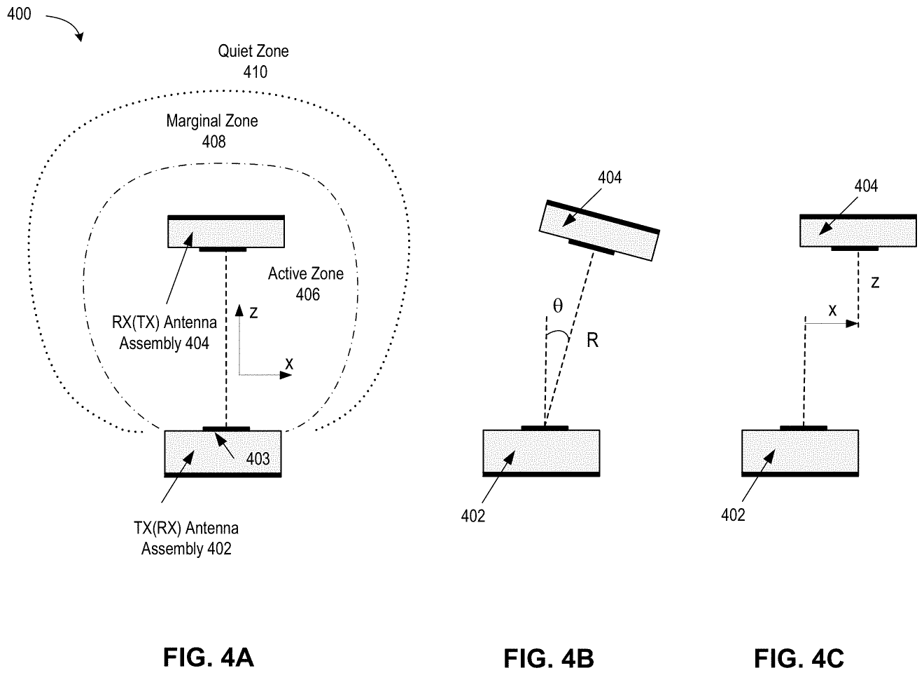

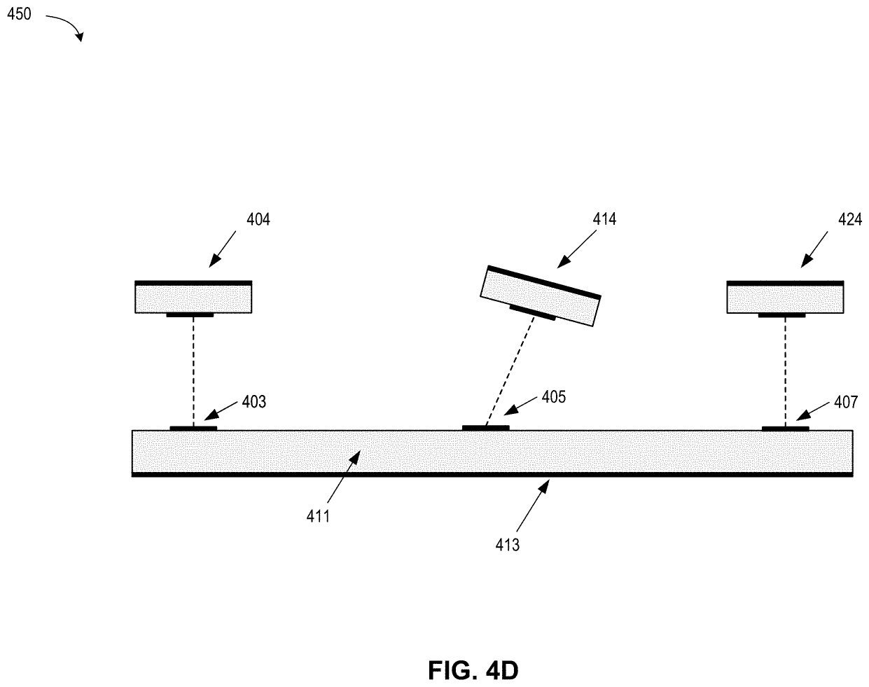

FIG. 4A is a schematic spatial characterization of the efficiency of a close-range communication that involves an antenna constructed in accordance with some implementations of the present disclosure. Depicted is a part 400 of a wireless network that includes a TX(RX) antenna assembly 402 capable of transmitting (or receiving) radio waves and an RX(TX) antenna assembly 404 capable of receiving (or transmitting) the radio waves and establishing a wireless communication link between respective devices (not shown explicitly) associated with the antenna assemblies 402 and 404. The antenna assemblies 402 and 404 may include close-range antennas configured to produce (when operating in a transmitting mode) electromagnetic field that has a signal strength sufficient for a reliable close-range communication while also having a reduced reach of the electromagnetic radiation into the far filed region. For example, when TX(RX) antenna assembly 402 is operating in a transmitting mode, several zones may be defined as being formed around an antenna 403 (e.g., a loop antenna) of the assembly.

Within an active zone 406, located inside a region depicted schematically with a dot-dashed line, the strength of the signal transmitted by antenna 403 may be at or above a certain first threshold S₁. The first threshold may depend on the size and other characteristics of a receiving antenna of the RX(TX) antenna assembly 404, on settings of amplifiers and other circuitry of the receiving device coupled to RX(TX) antenna assembly 404, and the like. In one example non-limiting implementation, S₁=−25 dB (whereas in other implementations, different threshold values, e.g., −20 dB, −30 dB, may exist). A good-quality communication link may be established inside the active zone 406 where signal strength S>S₁. A high-density network environment may be designed and set up in a way that limits a number of devices in the active zone 406 to a transmitting device and a receiving device with no other devices placed inside the active zone 406.

Outside the active zone 406 but within a marginal zone 408, depicted schematically with a dotted line, the strength of the signal transmitted by antenna 403 may be above a certain second threshold S₂ that is lower the first threshold. The second threshold may likewise depend on the specifics of the receiving device. In one example non-limiting implementation, S₂=−35 dB (or some other value, e.g., S₂=−30 dB, −40 dB, . . . ). A communication link with a receiving device inside the marginal zone 408 may be of a borderline quality. Accordingly, a high-density network environment may be designed and set up in such a way that placement of directly communicating devices is avoided in the marginal zone 408, where S₁>S>S₂. Likewise, placement of other devices within the marginal zones of two directly communicating devices may similarly be avoided, to limit effects of interference and noise generated by these communicating devices.

Outside the marginal zone 408 is a quiet zone 410 where the strength of the signal transmitted by antenna 403 is below the second threshold S₂. Devices in the quiet zone 410 do not receive detectable signals (or interference/noise) produced by the communicating devices. Similarly, two communicating devices that are within each other's active zone 406 are not disturbed by interference/noise produced by other devices of those other devices are located in the quiet zone 408. The loop antennas (and, more generally, the antenna assemblies) may be configured to make the marginal zone 408 as narrow as possible, to reduce the amount of space where quality of transmission/reception is borderline while interference and noise are substantial.

The boundary of the active zone 406 (and, similarly, of the marginal zone 408) may be identified from a signal strength map S(x, y, z) (the third dimension y is implied but not depicted explicitly in FIG. 4A) as the surface z(x, y) on which S(x, y, z)=S₁ (and similarly for the boundary between the marginal zone 408 and the quiet zone 410). Alternatively, the same boundary may be identified in the spherical coordinates (with the center of the coordinate system, e.g., being at the center of the antenna 403) as a function R (θ, ϕ), that expresses the distance to the boundary of the active zone 406 in terms of the polar angle θ and the azimuthal angle ϕ.

The boundary of the active zone 406, e.g., z(x, y) and/or R (θ, ϕ), as well as the boundary of the marginal zone 408, may be used to identify optimal locations and orientations of various devices of the wireless network. In some implementations, the optimal locations may be marked or otherwise defined for the ease of using. For example, locations for devices that connect to a charging pad or a testing bench may be defined using lines, notches, indentations, magnetic contacts, docking points, or via any other suitable means. For example, under the most favorable conditions, the antennas of two devices communicating with each other may be located directly opposite to each other, with no lateral or angle tilt, as shown in FIG. 4A. The following table illustrates a power transferred from a TX antenna to an RX antenna as a function of the vertical distance z between the centers of the respective antennas. (In this example, the TX antenna is supported by a silicon substrate.)

TABLE 1
Power transferred from an example TX
antenna for optimal TX/RX alignment

| z (mm) | S (dB) |
|---|---|
| 1.0 | −16.4 |
| 2.5 | −20.5 |
| 5.0 | −25.8 |
| 25.0 | −40.5 |
| 50.0 | −46.8 |

As follows from Table 1, for the referenced devices, the distance z=0.5 mm is close to the boundary between the active zone 406 and the marginal zone 408 whereas distance z=25 mm is well into the quiet zone 410.

As indicated by the extent of the active zone 406 in FIG. 4A, relative disposition of the TX antenna and the RX antenna may tolerate a certain angular or lateral misalignment. For example, a user may place a receiving (or transmitting) network device in such a way that the receiving (or transmitting) antenna is not fully aligned with its counterpart in the transmitting (or receiving) device. Likewise, various pre-determined docking locations or magnetic contacts may not ensure a full alignment. FIG. 4B depicts schematically an angular misalignment between transmitting and receiving antennas that still allows for an efficient close-range wireless communication. The following table illustrates a power transferred from a TX antenna to an RX antenna as a function of the tilt angle θ between the axes of the respective antennas. (In this example, the TX antenna is supported by a FR4 substrate.)

TABLE 2
Power transferred from an example TX
antenna with angular TX/RX misalignment

| z (mm) | θ (deg) | S (dB) |
|---|---|---|
| 1.0 | 0.0 | −9.59 |
| | 15.0 | −9.73 |
| 2.5 | 0.0 | −20.85 |
| | 15.0 | −20.65 |
| 5.0 | 0.0 | −25.07 |
| | 15.0 | −25.10 |
| 25.0 | 0.0 | −38.92 |
| | 15.0 | −39.50 |
| 50.0 | 0.0 | −45.42 |
| | 15.0 | −49.27 |

FIG. 4C depicts schematically a lateral misalignment between transmitting and receiving antennas that still allows for an efficient close-range wireless communication. The following table illustrates a power transferred from a TX antenna to an RX antenna as a function of the lateral displacement y between the axes of the respective antennas, for the vertical distance z=5 mm. (In this example, the TX antenna is supported by a FR4 Substrate.).

TABLE 3
Power transferred from an example TX
antenna with lateral TX/RX misalignment

| y (mm) | S (dB) |
|---|---|
| 0.0 | −25.1 |
| 1.0 | −24.9 |
| 2.5 | −25.3 |
| 5.0 | −28.3 |
| 25.0 | −48.3 |
| 50.0 | −58.2 |

Referring again to FIG. 4A, in some instance the RX(TX) antenna assembly 404 may be associated with a device that is not intended to communicate with antenna 403 of the TX(RX) antenna assembly 402. For example, the RX(TX) antenna assembly 404 may include a WiGig antenna. The WiGig antenna, being of a different construction than a close-range antenna, may not efficiently couple to the radiation by a close-range antenna. The following table illustrates a power transferred from a TX antenna to a WiGig RX antenna as a function of the vertical distance z between the centers of the two antennas.

TABLE 4
Power transferred from an example TX
antenna to an aligned WiGig antenna

| z (mm) | S (dB) |
|---|---|
| 25.0 | −32.5 |
| 30.0 | −34.5 |
| 40.0 | −38.5 |
| 50.0 | −42.5 |
| 60.0 | −45.0 |
| 75.0 | −47.0 |

Similarly, when a WiGig antenna is laterally displaced, as depicted in FIG. 4C, power transmission to the WiGig antenna may be further reduced. The following table illustrates a power transferred from a TX antenna to a laterally displaced WiGig RX antenna for the vertical distance z=25 mm.

TABLE 5
Power transferred from an example TX
antenna to a laterally displaced WiGig antenna

| y (mm) | S (dB) |
|---|---|
| 0.0 | −32.4 |
| 1.0 | −32.1 |
| 2.5 | −32.3 |
| 5.0 | −31.8 |
| 25.0 | −37.7 |
| 50.0 | −48.9 |

FIG. 4D is a schematic illustration of a wireless communication device 450 capable of supporting wireless communication links to multiple end devices, in accordance with some implementations of the present disclosure. Shown is a common substrate 411 and a common conducting layer 413. Three antennas (403, 405, and 407) are supported by the common substrate 411. Three wireless communication links are shown with devices whose RX(TX) antenna assemblies (404, 414, and 424) are also depicted. The close-range character of antennas 403, 405, and 407 ensures that each communication link suffers little if at all from interference/noise caused by the other communication links. Although only three communication links are shown in FIG. 4D for brevity and conciseness, a wireless communication device may support any number of such (suitably spaced) links.

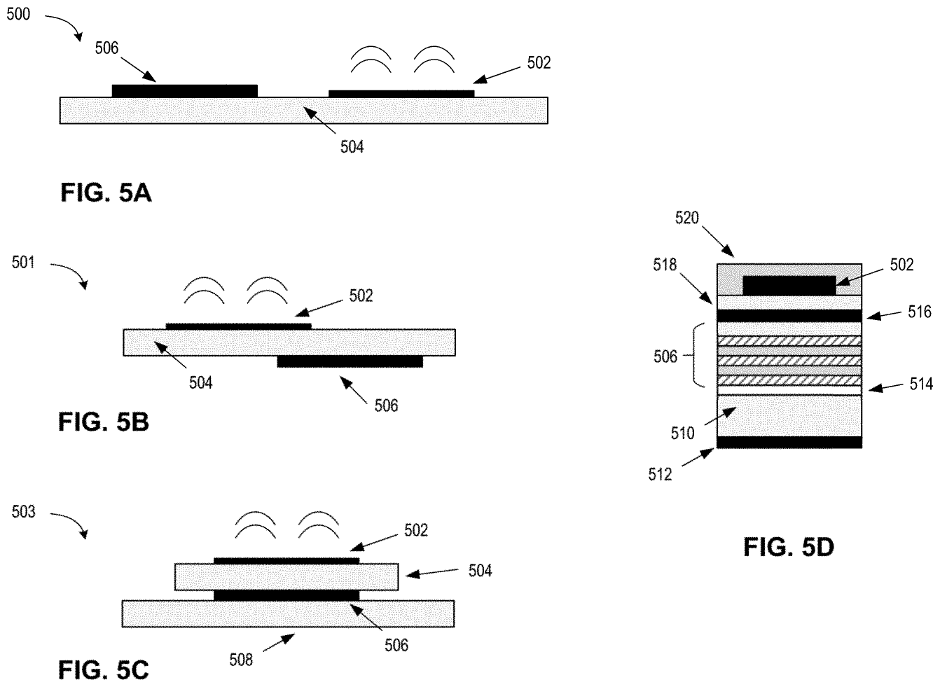

FIGS. 5A-C are schematic depictions of possible placements of a short range antenna for integration into a wireless network device, in accordance with some implementations of the present disclosure. FIG. 5A depicts an example side-by-side placement 500 of a close-range antenna 502 and a wireless network processor (WNP) 506 supported by the same laminate 504. Example placement shown in FIG. 5A is advantageous for its ease of fabrication but has a substantial footprint along the lateral direction. FIG. 5B depicts an example placement 501 of a close-range antenna 502 and a WNP 506 on opposite surfaces of the laminate 504. Shown is a placement with the close-range antenna 502 and WNP 506 partially overlapping with each other (in the direction along the surface of the laminate 504), but a complete overlap (e.g., over-and-under placement) may also be used in some implementations. Example placement 501 shown in FIG. 5B has an advantage over placement 500 in the reduced footprint. Moreover, a small size of the optimized close-range antenna 502 makes the advantages of placement 501 even more significant. Namely, with a large-size antenna (larger than the size of WNP 506), a relative reduction in the footprint of the combined device may be relatively small. Yet when the size of the close-range antenna 502 is similar to the size of WNP 506, the reduction of the footprint compared with placement 500 may be close to 50%.

FIG. 5C depicts an example placement 503 in which a close-range antenna 502 is integrated with WNP 506 into a single bundle device. More specifically, the close-range antenna 502 may be manufactured as a combined module that includes laminate 504 separating the close-range antenna 502 from WNP 506 and a second laminate 508 serving as a support for WNP 506. FIG. 5D depicts an example cross section of the combined bundle device of FIG. 5C. Second laminate 508 may include a silicon layer 510 supported by a conducting layer 512. An insulating layer 514 (e.g., a silicon dioxide layer) may be placed on top of silicon layer 510 and WNP 506 (that may have one or more layers inside) may be deposited thereupon. Conducting layer 516 and substrate 518 may support close-range antenna 502, and a passivation layer 520 may cover close-range antenna 502, to prevent close-range antenna 502 from oxidation and other adverse environmental conditions. Although FIG. 5D depicts two conducting layers, in some implementations one of the conducting layers, e.g., conducting layer 512 or conducting layer 516, may be absent. In some implementations, both conducting layer 512 and conducting layer 516 may be absent. Instead, a conducting layer may be implemented as one of the layers of WNP 506.

Example implementations of the instant disclosure are further illustrated with examples set forth below and the various features of such example implementations may be claimed alone or in combination with one another. In one example, an antenna assembly (e.g., antenna assembly 300 of FIG. 3) is disclosed that includes a loop antenna (e.g., loop antenna 302) and a feed line (e.g., feed line 312) electromagnetically coupled to the loop antenna. Electromagnetic coupling may be of any suitable type: a wire contact, a capacitive coupling, an inductive coupling, or any combination thereof. The antenna assembly further includes a substrate support (e.g., substrate 304) in contact with the loop antenna. The substrate support includes a plurality of layers and may be configured to reduce a ratio S(1)/S(2) of a first strength S(1) of electromagnetic field generated by the loop antenna in a first region (1) to a second strength S(2) of electromagnetic field generated by the loop antenna in a second region (2). For example, the first region (1) may be in the far field domain of the antenna (e.g., at distance of 50 mm) and may be farther away from the loop antenna than the second region (2), which may be in the near field domain of the antenna (e.g., closer than 10 mm).

In one example, the plurality of layers of the antenna assembly includes a conducting layer (e.g., conducting layer 308) and a first non-conducting layer (e.g., substrate 304) that separates the loop antenna from the conducting layer.

In one example, the feed line is configured to provide, to the loop antenna, a signal having an operational frequency, e.g., frequency between 30 GHz and 100 GHz. In one specific example, operational frequency may be between 56 GHz and 72 GHz, although other signals with other operational frequencies may be provided. The first non-conducting layer may be made of (or include) a material having a thickness that is less than a wavelength of light in the material (e.g., λ), wherein the wavelength of light is determined for the operational frequency (e.g., λ=f/(nc)).

In one example, the plurality of layers further includes a second non-conducting layer (e.g., a layer that includes silicon dioxide) different from the first non-conducting layer (e.g., a layer that includes silicon) and disposed between the first non-conducting layer and the loop antenna. In one specific example, a thickness of the second non-conducting layer is at least ten times less than a thickness of the first non-conducting layer.

In one example, the loop antenna has a rectangular shape with the largest dimension (e.g., circumference of the antenna) not exceeding twice a wavelength of light in air (2λ₀), the wavelength of light in air determined for the operational frequency of the loop antenna (λ₀=f/c).

In one example, the loop antenna has an operational bandwidth that is at least 8 GHz. In other examples, the loop antenna has an operational bandwidth that is at least 4 GHz, 2 GHz, 1 GHz, or any other suitable value.

In one example, disclosed is an antenna assembly that includes a loop antenna having an operational frequency between 50 GHz and 70 GHz, and further includes a substrate supporting the loop antenna, the substrate having a conducting layer and a dielectric layer (e.g., a silicon layer, an FR4 layer, or any other dielectric layer). In one specific example, the dielectric layer is disposed between the loop antenna and the conducting layer and a distance from the conducting layer to the loop antenna is less than a first wavelength of light (e.g., λ) in the dielectric layer, wherein the first wavelength of light is determined for the operational frequency (e.g., λ=f/(nc)).

In one example, the distance from the conducting layer to the loop antenna is less than one quarter of the first wavelength of light (λ/4).

In one example, conductivity of the conducting layer is at least one million Siemens per meter and conductivity of the dielectric layer is at most one hundred Siemens per meter.

In one example, a maximum of a circumference of the loop antenna is less than a second wavelength of light in air λ₀, wherein the second wavelength of light is determined at the operational frequency (λ₀=f/c).

In one example, disclosed is a system for wireless communications that includes a first antenna (e.g., antenna 403 of FIG. 4A) having an operational frequency between 50 GHz and 70 GHz and a circumference that is less than twice a wavelength of light at the operational frequency and a first substrate support for the first antenna. The first substrate support may include a first conducting screen. The system further includes a first radio communicatively coupled to the first antenna, the first radio to support a first wireless communication link (WCL) with a second radio coupled to that comprises a second antenna. For example, the second transceiver may be a transceiver associated and interacting with RX(TX) antenna assembly 404. The first WCL may be characterized by a first strength of transmitted power that is at least −20 dB at a first location where the second antenna (e.g., antenna of the RX(TX) antenna assembly 404) is located. The first WCL is further characterized by a second strength of transmitted power that is at most −35 dB at a second location that is in a quiet zone (e.g., quiet zone 410 of FIG. 4A). In one specific example, the second location may be at a distance, from the first antenna, that is at most ten times a distance from the first antenna to the first location.

In one example, the distance (e.g., z or \sqrt{z²+x²}) from the first antenna to the first location (where the second antenna is located) is less than 10 mm.

In one example, the system for wireless communications further includes an antenna matching network for the first antenna, the antenna matching network configured to support at least a 1 GB bandwidth of the first WCL.

In one example, the system for wireless communications further includes a third antenna and a second substrate support for the third antenna, the second substrate support including a second conducting layer. The system may further include a second radio communicatively coupled to the third antenna, the second radio supporting a second WCL with a fourth radio (to establish a communication link that is different from the communication link between the first antenna and the second antenna). The third antenna may be located a distance from the first antenna that is at most ten times the distance from the first antenna to the first location (e.g., distance z or \sqrt{z²+x²}).

In one example, the first substrate support and the second substrate support are different portions of the same substrate layer (e.g., manufactured using the same deposition process). Likewise, the first conducting screen and the second conducting screen are different portions of the same conducting layer.

In one example, the first WCL and the second WCL use the same operational frequency between 50 GHz and 70 GHz.

In one example, as shown in FIG. 4D, the system for wireless communications has three or more antennas (including the first antenna and the third antenna) and three or more radios (including the first radio and the second radio). In one specific example, the three or more antennas and the three or more radios are part of a wireless testing bench or a wireless charging mat. In one specific example, at least one of the three or more antennas is a Wireless Gigabit (WiGig) antenna.

In one example, as shown in FIG. 5B, the system for wireless communications further includes a wireless network processor (e.g., WNP 506) disposed on a side of the first substrate support (e.g., laminate 504) that is opposite to a side in contact with the first antenna (e.g., close-range antenna 502). The first antenna and the wireless network processor may have at least partially overlapping footprints (in the direction along the film).

In one example, as shown in FIG. 5C, the first substrate (e.g., laminate 504) is disposed (directly or via one or more intervening materials) on a wireless network processor (e.g., WNP 506). In some implementations, the first substrate may be deposited (e.g., during substrate manufacturing process) on the wireless network processor.

It should be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The implementations of methods, hardware, software, firmware or code set forth above may be implemented via instructions or code stored on a machine-accessible, machine readable, computer accessible, or computer readable medium which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one implementation” or “an implementation” means that a particular feature, structure, or characteristic described in connection with the implementation is included in at least one implementation of the disclosure. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

In the foregoing specification, a detailed description has been given with reference to specific exemplary implementations. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of implementation, implementation, and/or other exemplarily language does not necessarily refer to the same implementation or the same example, but may refer to different and distinct implementations, as well as potentially the same implementation.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Also, the terms “first,” “second,” “third,” “fourth,” etc. as used herein are meant as labels to distinguish among different elements and may not necessarily have an ordinal meaning according to their numerical designation.

1. An antenna assembly comprising:
a loop antenna;
a feed line electromagnetically coupled to the loop antenna; and
a substrate support in contact with the loop antenna, the substrate support comprising a plurality of layers and configured to reduce a ratio of a first strength of electromagnetic field, generated by the loop antenna in a first region, to a second strength of electromagnetic field, generated by the loop antenna in a second region, wherein the first region is farther away from the loop antenna than the second region.

2. The antenna assembly of claim 1, wherein the plurality of layers comprises:
a conducting layer; and
a first non-conducting layer separating the loop antenna from the conducting layer.

3. The antenna assembly of claim 2, wherein the feed line is configured to provide, to the loop antenna, a signal having an operational frequency, and wherein the first non-conducting layer comprises a material having a thickness that is less than a wavelength of light in the material, wherein the wavelength of light is determined at the operational frequency.

4. The antenna assembly of claim 2, wherein the plurality of layers further comprises a second non-conducting layer different from the first non-conducting layer and disposed between the first non-conducting layer and the loop antenna, a thickness of the second non-conducting layer being at least ten times less than a thickness of the first non-conducting layer.

5. The antenna assembly of claim 2, wherein the first non-conducting layer comprises at least one of silicon or FR4 layered material.

6. The antenna assembly of claim 1, wherein the loop antenna has a rectangular shape with a circumference of the antenna not exceeding twice a wavelength of light in air, wherein the wavelength of light is determined at an operational frequency of the loop antenna.

7. The antenna assembly of claim 1, wherein a loop antenna has an operational frequency between 30 GHz and 100 GHz.

8. The antenna assembly of claim 2, wherein the loop antenna has an operational bandwidth that is at least 8 GHz.

9. An antenna assembly comprising:
a loop antenna having an operational frequency between 50 GHz and 70 GHz; and
a substrate supporting the loop antenna, the substrate comprising a conducting layer and a dielectric layer, wherein the dielectric layer is disposed between the loop antenna and the conducting layer, wherein a distance from the conducting layer to the loop antenna is less than a first wavelength of light in the dielectric layer, wherein the first wavelength of light is determined at the operational frequency.

10. The antenna assembly of claim 9, wherein the distance from the conducting layer to the loop antenna is less than one quarter of the first wavelength of light.

11. The antenna assembly of claim 9, wherein conductivity of the conducting layer is at least one million Siemens per meter and conductivity of the dielectric layer is at most one hundred Siemens per meter.

12. The antenna assembly of claim 9, wherein a circumference the loop antenna is less than a second wavelength of light in air, wherein the second wavelength of light is determined at the operational frequency.

13. A system for wireless communications, the system comprising:
a first antenna having an operational frequency between 50 GHz and 70 GHz and a circumference that is less than twice a wavelength of light at the operational frequency;
a first substrate support for the first antenna, the first substrate support comprising a first conducting screen; and
a first radio communicatively coupled to the first antenna, the first radio to support a first wireless communication link (WCL) with a second radio coupled to a second antenna.

14. The system of claim 13, further comprising an antenna matching network for the first antenna, the antenna matching network configured to support at least a 1 GB bandwidth of the first WCL.

15. The system of claim 13, further comprising:
a third antenna;
a second substrate support for the third antenna, the second substrate support comprising a second conducting screen; and
a second radio communicatively coupled to the third antenna, the second radio to support a second WCL with a fourth radio, wherein the third antenna is at a distance from the first antenna that is at most ten times the distance from the first antenna to the second antenna.

16. The system of claim 15, wherein the first substrate support and the second substrate support are different portions of a same substrate layer, and wherein the first conducting screen and the second conducting screen are different portions of a same conducting layer.

17. The system of claim 15, wherein the third antenna has the operational frequency between 50 GHz and 70 GHz.

18. The system of claim 13, wherein the first WCL is characterized by:
a first strength of transmitted power that is at least −20 dB at a first location, the first location being a location of the second antenna, and
a second strength of transmitted power that is at most −35 dB at a second location, wherein the second location is at a distance, from the first antenna, that is at most ten times a distance from the first antenna to the first location.

19. The system of claim 18, wherein the distance from the first antenna to the first location is less than 10 mm.

20. The system of claim 13, further comprising:
three or more antennas, wherein the three or more antennas comprise the first antenna; and
three or more radios, wherein the three or more radios comprise the first radio.

21. The system of claim 20, wherein the three or more antennas and the three or more radios are part of a wireless testing bench or a wireless charging mat.

22. The system of claim 20, wherein at least one of the three or more antennas is a Wireless Gigabit (WiGig) antenna.

23. The system of claim 13, further comprising a wireless network processor disposed on a side of the first substrate support that is opposite to a side in contact with the first antenna, the first antenna and the wireless network processor having at least partially overlapping footprints.

24. The system of claim 13, wherein the first substrate is disposed on a wireless network processor.
